(19) United States
(12) Patent Application Publication
(10) Pub. No.: US 2025/0313101 A1
(43) Pub. Date: Oct. 9, 2025

(54) Self-Charging Battery-Powered Electric Vehicle

(71) Applicant: Herns Louis, Moreno Valley, CA (US)

(72) Inventor: Herns Louis, Moreno Valley, CA (US)

(21) Appl. No.: 19/077,168

(22) Filed: Mar. 12, 2025

Related U.S. Application Data
(60) Provisional application No. 63/573,674, filed on Apr. 3, 2024.

(51) Int. Cl. B60L 50/75; B60L 53/54; B60L 58/18; H01M 8/04082; H01M 8/10; H01M 10/46; H01M 16/00; H02J 7/34

(52) U.S. Cl. CPC B60L 50/75; B60L 53/54; B60L 58/18; H01M 8/04201; H01M 10/46; H01M 16/006; H02J 7/34; H01M 2008/1095; H01M 2220/20; H01M 2250/20; H01M 2250/402

(57) ABSTRACT

The present invention is a self-charging battery-powered electric vehicle (EV) that integrates a dual traction battery system and a hydrogen fuel cell to enhance driving range and efficiency. The EV features a first traction battery pack and a second traction battery pack, wherein a power controller automatically switches between battery packs and enables the hydrogen fuel cell to recharge the inactive pack while driving. A hydrogen fuel cell system, coupled with swappable (i.e., selectively removable) and fixed hydrogen tanks, generates electricity for battery charging and direct propulsion. Additionally, a hydrogen tank swapping station provides secure and automated hydrogen refueling. The system optimizes energy distribution based on driving patterns, terrain, and climate conditions.

### CROSS-REFERENCE TO RELATED APPLICATION

The present application claims priority to, and the benefit of, U.S. Provisional Application No. 63/573,674 which was filed on Apr. 3, 2024 and is incorporated herein by reference in its entirety.

### FIELD OF THE INVENTION

The present invention generally relates to electric vehicle (EV) power management systems. More specifically, the invention relates to a self-charging battery-powered electric vehicle that integrates a dual traction battery system and a hydrogen fuel cell. The system includes a power controller that switches between a first traction battery pack and a second traction battery pack. Additionally, the invention features a hydrogen fuel cell system with both fixed and swappable (i.e., selectively removable) hydrogen tanks, enabling real-time battery recharging while the vehicle is in motion. Accordingly, the present disclosure makes specific reference thereto. Nonetheless, it is to be appreciated that aspects of the present invention are also equally applicable to other like applications, devices, and methods of manufacture.

### BACKGROUND

By way of background, electric vehicles (EVs) have gained significant traction as a sustainable alternative to internal combustion engine (ICE) vehicles, offering advantages such as zero tailpipe emissions, reduced reliance on fossil fuels, and lower long-term operating costs. Governments and industries worldwide are actively promoting EV adoption to combat climate change and transition towards cleaner transportation. However, unlike traditional ICE vehicles, which can be refueled within minutes at readily available gas stations, most EVs have a limited driving range of approximately 200-300 miles per charge. For long-distance travel, this limitation can be a major inconvenience, as charging infrastructure remains insufficient in many regions, particularly in rural and less densely populated areas.

Furthermore, while advancements in fast-charging technology have improved charging times, many public charging stations remain slow, requiring 30 minutes to several hours for a full charge. The uneven distribution of charging stations, coupled with high demand in urban areas, further exacerbates this problem. Additionally, cold and hot weather conditions can negatively impact battery performance and efficiency, further reducing range and making EVs less reliable in extreme climates. Accordingly, individuals desire an improved electric vehicle that has improved driving range and has reduced dependency on external charging stations.

Therefore, there exists a long-felt need in the art for a self-charging battery-powered electric vehicle that addresses the limitations of conventional EVs, including range anxiety, limited charging infrastructure, and prolonged charging times. Specifically, there is a long-felt need for an EV system that integrates real-time power management and automatic energy replenishment.

Furthermore, there is a long-felt need for a system that can switch between multiple power sources, such as dual traction battery packs and a hydrogen fuel cell. Additionally, there is a need for a solution that uses hydrogen-based recharging, enabling the vehicle to sustain long-distance travel. Moreover, there is a need for an intelligent energy distribution system that automatically allocates power based on driving conditions, road terrain, and climate factors. Finally, there is a need for a versatile and scalable EV power system that can be implemented in both new vehicle designs and retrofitted onto existing electric vehicle platforms, providing a practical and sustainable transportation solution.

The subject matter disclosed and claimed herein, in one embodiment, comprises a self-charging electric vehicle (EV) that integrates a dual traction battery system with a hydrogen fuel cell for enhanced energy management and range extension. The system includes a first traction battery pack and a second traction battery pack, wherein the first battery pack is the primary power source for the electric traction motor. A power controller is configured to monitor the battery state of charge (SOC) and automatically switch to the second battery pack when the first reaches a predetermined depletion level. Simultaneously, a hydrogen fuel cell system, coupled with swappable (i.e., selectively removable) and fixed hydrogen tanks, generates electricity to recharge the inactive battery pack while the EV remains in operation. The system also incorporates an onboard charging module, which facilitates real-time energy transfer.

In this manner, the self-charging battery-powered electric vehicle of the present invention addresses the limitations of conventional EVs by providing an improved EV which provides continuous power replenishment mechanism and reduces dependency on external charging infrastructure. The dual traction battery system and the hydrogen fuel cell make long-distance travel more practical. The vehicle incorporates swappable (i.e., selectively removable) hydrogen tanks to provide a quick refueling alternative, enabling users to replace depleted tanks at designated swapping stations rather than waiting for long hydrogen refills.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-charging battery-powered electric vehicle (EV). The electric vehicle comprises a first traction battery pack having a first energy storage capacity and configured to provide power to an electric traction motor of the EV, a second traction battery pack having a second energy storage capacity greater than the first traction battery pack, the second traction battery pack being selectively activatable to provide power to the electric traction motor, a hydrogen fuel cell configured to generate electricity from hydrogen stored in at least one fixed hydrogen tank and a plurality of swappable (i.e., selectively removable) hydrogen tanks, and a power controller is configured to monitor a state of charge of the first and second traction battery packs, wherein upon detecting that the first traction battery pack has reached a preset charge threshold, the power controller automatically switches power delivery to the electric traction motor from the first traction battery pack to the second traction battery pack.

In another aspect, when the second traction battery pack is supplying power to the electric traction motor, the hydrogen fuel cell automatically recharges the first traction battery pack and wherein the power controller automatically manages cyclic charging of the battery packs without interrupting vehicle operation.

In one embodiment, a self-charging battery-powered electric vehicle (EV) is disclosed. The EV comprises an electric traction motor for propulsion of the EV, at least one fixed hydrogen tank and a plurality of swappable (i.e., selectively removable) hydrogen tanks, each configured to store compressed hydrogen gas, a hydrogen fuel cell is coupled to the fixed and swappable (i.e., selectively removable) hydrogen tanks, the hydrogen fuel cell being configured to convert hydrogen into electricity to power the electric traction motor and recharge at least one traction battery pack. A battery pack system comprises a first traction battery pack and a second traction battery pack, wherein one of the battery packs supplies power to the electric traction motor while the hydrogen fuel cell recharges the other battery pack, and wherein the vehicle further comprises an onboard charging module that facilitates the charging of the traction battery packs from the hydrogen fuel cell while the EV is in motion, thereby extending the vehicle's range.

In yet another aspect, a self-charging battery-powered electric vehicle (EV) is disclosed. The EV comprises an electric traction motor configured to be powered by a combination of a dual traction battery pack system and a hydrogen fuel cell, a first traction battery pack and a second traction battery pack, wherein a power controller manages power switching and charging between the two battery packs, a hydrogen fuel cell system including at least one fixed hydrogen tank and a plurality of swappable (i.e., selectively removable) hydrogen tanks, the hydrogen fuel cell being configured to generate electricity for battery charging and direct propulsion, wherein a power controller dynamically adjusts power delivery from the traction battery packs and hydrogen fuel cell based on real-time driving conditions and preemptively transfers charge between the first and second traction battery packs before depletion.

In still another embodiment, the hydrogen fuel cell is used as the primary power source for the electric traction motor to compensate for reduced battery efficiency at low temperatures.

In yet another embodiment, the artificial intelligence (AI)-based power controller analyzes historical driving patterns, road gradients, and energy consumption rates and preemptively initiates hydrogen fuel cell operation to begin recharging the battery pack expected to deplete first.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of self-charging battery powered electric vehicle of the present invention in accordance with the disclosed architecture;

FIG. 2 illustrates a perspective view showing the swappable (i.e., selectively removable) hydrogen tank ports and fixed hydrogen fuel tank neck disposed in the hybrid electric vehicle of the present invention in accordance with the disclosed structure;

FIG. 3 illustrates a schematic view showing a layout of the traction battery pack system used in the hybrid electric vehicle of the present invention;

FIG. 4 illustrates a flow chart depicting switching between the traction battery packs in accordance with one embodiment of the present invention;

FIG. 5 illustrates a perspective view of a hydrogen tank swapping station for swapping the swappable (i.e., selectively removable) hydrogen tanks in accordance with the disclosed structure; and

FIG. 6 illustrates a perspective view of another embodiment of the hybrid electric vehicle of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a self-charging battery-powered electric vehicle that addresses the limitations of conventional EVs, including range anxiety, limited charging infrastructure, and prolonged charging times. Specifically, there is a long-felt need for an EV system that integrates real-time power management and automatic energy replenishment. Furthermore, there is a long-felt need for a system that can switch between multiple power sources, such as dual traction battery packs and a hydrogen fuel cell. Additionally, there is a need for a solution that uses hydrogen-based recharging, enabling the vehicle to sustain long-distance travel. Moreover, there is a need for an intelligent energy distribution system that automatically allocates power based on driving conditions, road terrain, and climate factors. Finally, there is a need for a versatile and scalable EV power system that can be implemented in both new vehicle designs and retrofitted onto existing electric vehicle platforms, providing a practical and sustainable transportation solution.

The present invention, in one exemplary embodiment, is a self-charging battery-powered electric vehicle (EV). The EV comprises an electric traction motor configured to be powered by a combination of a dual traction battery pack system and a hydrogen fuel cell, a first traction battery pack and a second traction battery pack, wherein a power controller manages power switching and charging between the two battery packs, a hydrogen fuel cell system including at least one fixed hydrogen tank and a plurality of swappable (i.e., selectively removable) hydrogen tanks, the hydrogen fuel cell being configured to generate electricity for battery charging and direct propulsion, wherein a power controller dynamically adjusts power delivery from the traction battery packs and hydrogen fuel cell based on real-time driving conditions and preemptively transfers charge between the first and second traction battery packs before depletion.

Reference will now be made in detail to the present preferred embodiments of the invention, examples of which are illustrated in the accompanying drawings. Wherever possible, the same reference numerals are used in the drawings and the description to refer to the same or like parts.

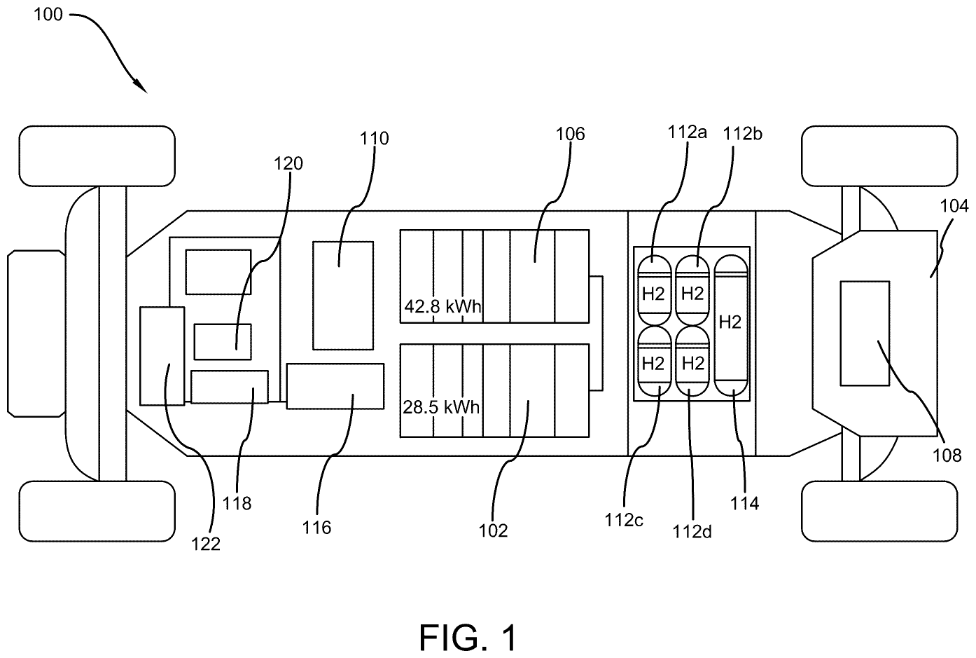

Referring initially to the drawings, FIG. 1 illustrates a top view of self-charging battery powered electric vehicle of the present invention in accordance with the disclosed architecture. The self-charging battery powered electric vehicle 100 of the present invention is an advanced electric vehicle (EV) that integrates a dual power source including rechargeable traction battery packs and hydrogen fuel cells. The EV 100 has an improved driving range and efficiency and enables the traction battery packs to recharge while driving.

The EV 100 includes a first traction battery pack 102 which preferably has a capacity from 20 kWh to 38 kWh. The first traction battery pack 102 forms the primary source for providing power to an electric traction motor 104 of the EV 100. A second traction battery pack 106 is included in the EV 100 and has a higher capacity than the first traction battery pack 102. In the preferred embodiment, the second traction battery pack 106 has a capacity from 36 kWh to 50 kWh. In use, when the charge from the first traction battery pack 102 drops to a predetermined level of 20%, or lower, of the total capacity of the first traction battery pack 102, a power controller 108 switches the power source to the second battery pack 106. The dual traction battery packs 102, 106 are preferably used for short and local trips to provide electric power to the electric traction motor 104.

A hydrogen fuel cell 110 is included in the EV 100. The hydrogen fuel cell 110 is coupled to a plurality of removable and swappable (i.e., selectively removable) hydrogen tanks 112a-d and at least one fixed hydrogen tank 114. The hydrogen fuel cell 110 is configured to charge the first traction battery pack 102 when the first battery pack 102 is not in use for driving the electric traction motor 104. Similarly, when the second traction battery pack 106 is recharged by the module 110, when the second traction battery pack 106 is not in use. Also, during long-distance travels, the hydrogen tanks 112a-d, 114 serve as the primary power source for the electric traction motor, enabling the electric vehicle 100 to cover long distances without requiring frequent charging stops.

The hydrogen fuel cell 110 is configured to convert hydrogen from the hydrogen tanks into electricity, with water and heat as byproducts, wherein the electricity is used for recharging the traction battery packs 102, 106 and powering the electric traction motor 104. An onboard charging module 116 monitors the electric power from the hydrogen fuel cell 110 and enables the hydrogen fuel cell 110 to recharge the battery packs 102, 106 while the EV 100 is in motion.

The battery packs 102, 106 are preferably lithium-ion batteries and have high energy density, and power output. The hydrogen fuel cell 110 is preferably a Proton Exchange Membrane (PEM) fuel cell and uses a membrane to separate hydrogen ions from electrons, generating electricity, water, and heat as byproducts. The hydrogen tanks 112a-d, 114 preferably store compressed hydrogen gas which is used by the hydrogen fuel cell 110 for producing electricity.

The EV 100 uses at least one DC-DC converter 118 to convert the voltage from the hydrogen fuel cell 110 and batteries 102, 106 to the appropriate level for the motor 104 and other electrical systems of the EV 100. The DC-DC converter 118 can have an embedded inverter to convert the DC electricity from the batteries 102, 106 and fuel cell 110 to AC electricity to drive the motor 106. An onboard charger 120 is also included in the EV 100 for providing recharging of the battery packs 102, 106 using conventional charging stations for the EV battery packs.

In the present embodiment, a hydrogen supply module 122 is embedded in the EV 100 which is configured to provide hydrogen supply to hydrogen tanks 112a-d, 114 using an external supply of hydrogen. Further, each swappable (i.e., selectively removable) hydrogen tank can be designed to store up to 2 kg of compressed hydrogen gas and the fixed hydrogen tank 114 can store up to 3 kg of compressed hydrogen gas.

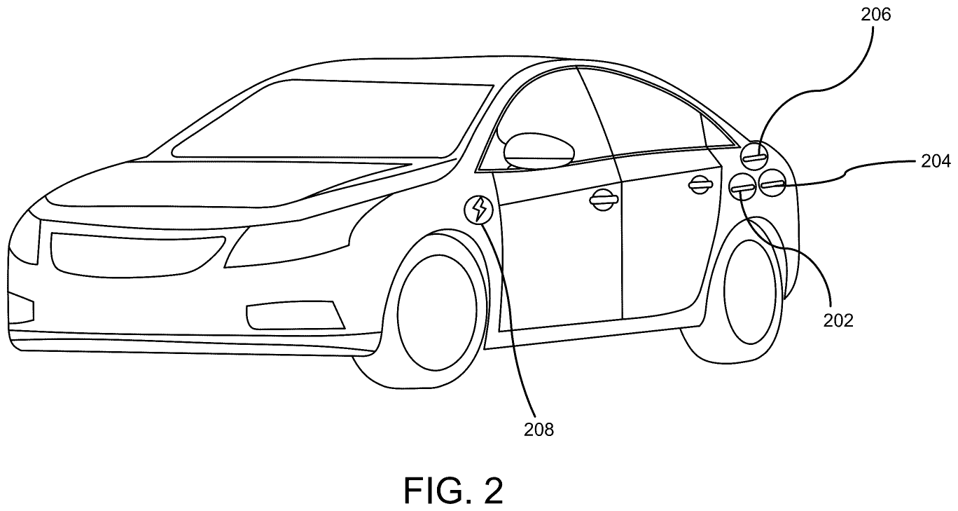

FIG. 2 illustrates a perspective view showing the swappable (i.e., selectively removable) hydrogen tank ports and fixed hydrogen fuel tank neck disposed in the hybrid electric vehicle of the present invention in accordance with the disclosed structure. The hybrid electric vehicle 100 of the present invention includes a plurality of swappable (i.e., selectively removable) hydrogen tanks 112a-d for providing additional electric power using the hydrogen fuel cell 110. The swappable (i.e., selectively removable) tanks 112c, 112d can be pulled out and inserted into their corresponding modules using the swappable (i.e., selectively removable) hydrogen tank ports 202, 204. It should be noted that corresponding ports for the tanks 112a, 112b can be disposed on opposite side of the EV 100. For accessing the fixed hydrogen tank 114, a fuel tank neck 206 is disposed in the EV 100. For directly charging the traction battery packs 102, 106, an EV charging port 208 is disposed in the EV 100 and can be used by a user for conventionally charging at an EV charging station.

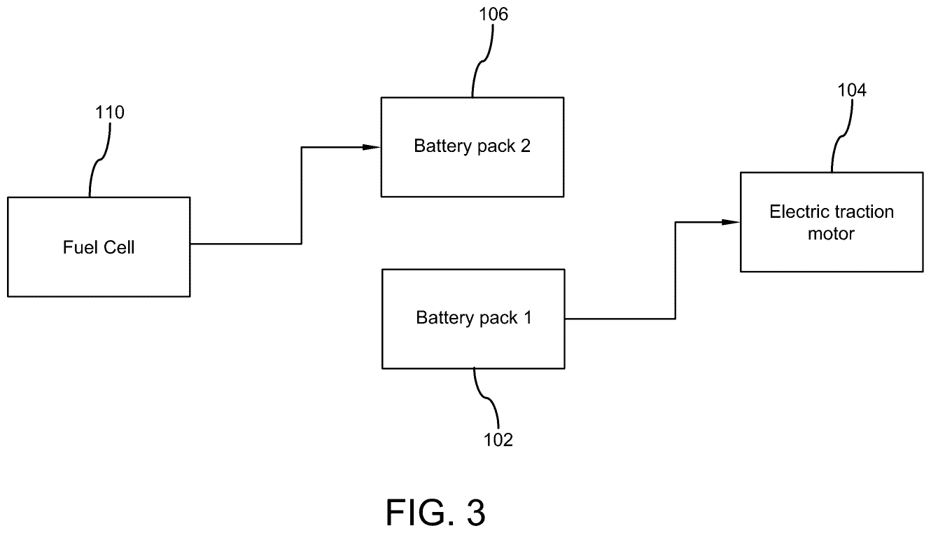

FIG. 3 illustrates a schematic view showing a layout of the traction battery pack system used in the hybrid electric vehicle of the present invention. The battery packs 102, 106 provide electric power to the electric traction motor 104 and specifically, only one battery pack of the battery packs 102, 106 provide the power to the motor 104 at an instance. As illustrated, the first battery pack 102 provides power to the motor 104 and simultaneously, the hydrogen fuel cell 110 using the hydrogen tanks 112a-d, 114 recharge the other battery pack 106, thereby helping in extending the range of the EV 100. Similarly, when the second battery pack 106 provides electric power to the motor 104, the hydrogen fuel cell 110 charges the first battery pack 102. It should be noted that the automatic switching between the battery packs 102, 106 is maintained by the power controller 108 and does not obstruct the operation of the hybrid EV 100.

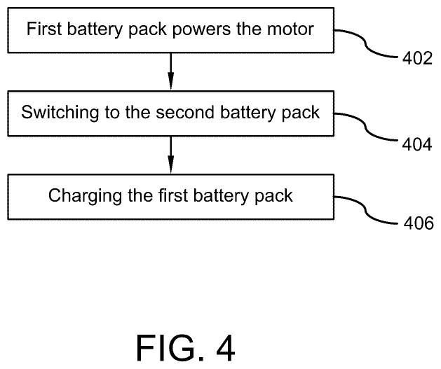

FIG. 4 illustrates a flow chart depicting switching between the traction battery packs in accordance with one embodiment of the present invention. Initially, on the EV startup, the first battery pack (20 to 38 kWh) 102 powers the motor 104 and is being continuously monitored by the controller 108 (Step 402). When the first battery pack 102 reaches a predetermined battery level, the controller switches to the second pack 106 (Step 404). Also, charging the first pack 102 using the hydrogen fuel cell 110 is initiated for recovery of the first pack 102 (Step 406). In some embodiments, the EV 100 implements artificial intelligence (AI) that predicts energy needs and preemptively transfers charge between packs 102, 106 before depletion.

In some embodiments, during braking or coasting, kinetic energy is converted into electrical energy and can be stored in the unused battery pack. For example, if the first battery pack 102 is active and providing power to the electric traction motor 104, the regenerative energy is stored in the second battery pack 106.

The controller 108 and the onboard charging module 116 can be adapted to detect climate conditions enabling the hydrogen fuel cell 110 to be used as primary power source to prevent battery inefficiency. In long-distance, the hydrogen fuel cell 110 directly powers the traction motor 104.

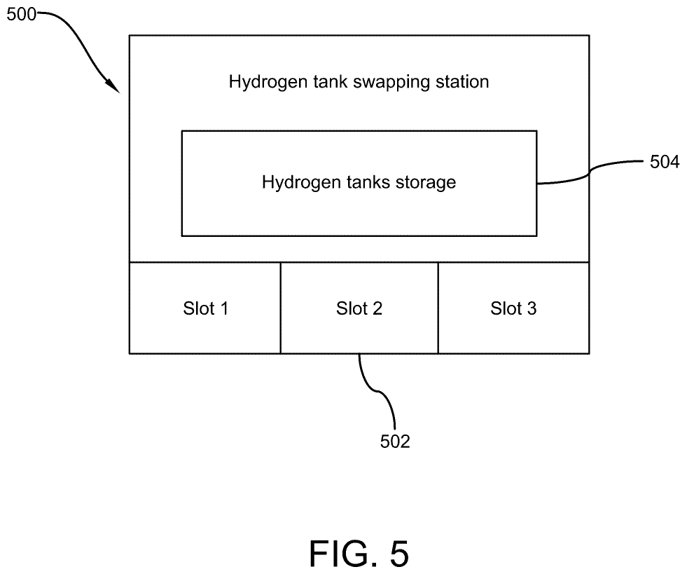

FIG. 5 illustrates a perspective view of a hydrogen tank swapping station for swapping the swappable (i.e., selectively removable) hydrogen tanks in accordance with the disclosed structure. The hydrogen tank swapping station 500 can be placed at any convenient location such as a near an EV charging station or any other location as per preferences of EV owners. In the present embodiment, the station 500 includes a plurality of swapping slots 502 where the swappable (i.e., selectively removable) hydrogen tank ports 202, 204 can be positioned to automatically swap the swappable (i.e., selectively removable) hydrogen tanks. The tanks can also be replaced and swapped manually by drivers of the EVs without any additional professional help. The station 500 includes a storage space 504 which is adapted to store a plurality of filled hydrogen tanks and further, the station 500 may have a hydrogen supply for automatically filling the empty hydrogen tanks.

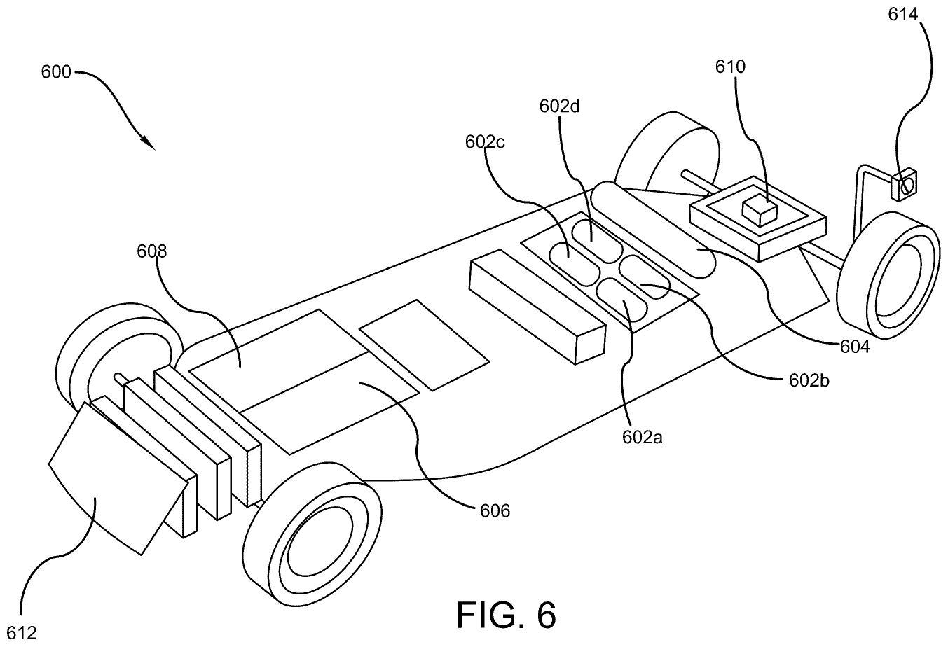

FIG. 6 illustrates a perspective view of another embodiment of the hybrid electric vehicle of the present invention in accordance with the disclosed structure. In the present embodiment, the hybrid electric vehicle 600 includes four swappable (i.e., selectively removable) hydrogen tanks 602a-d, a fixed hydrogen tank 604 for charging a pair of traction battery packs 606, 608 and providing power to an electric traction motor 610. The electric vehicle 600 also includes a cooling module 612 and a fuel filler 614 for filling and filtering fuel. It should be noted that any other conventional components necessary for operation of the vehicle 600 are not shown for simplicity and brevity of the disclosure.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-charging battery powered electric vehicle”, “hybrid electric vehicle”, “self-charging electric vehicle with dual traction battery system”, and “system” are interchangeable and refer to the self-charging hybrid electric vehicle 100, 600 of the present invention.

Notwithstanding the forgoing, the self-charging hybrid electric vehicle 100, 600 of the present invention can be of any suitable configuration as is known in the art without affecting the overall concept of the invention, provided that it accomplishes the above stated objectives. One of ordinary skill in the art will appreciate that the self-charging hybrid electric vehicle 100, 600 as shown in the FIGS. are for illustrative purposes only, and that many other configurations of the self-charging hybrid electric vehicle 100, 600 are well within the scope of the present disclosure. Although the dimensions of the self-charging hybrid electric vehicle 100, 600 are important design parameters for user convenience, the self-charging hybrid electric vehicle 100, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-charging battery powered electric vehicle comprising:
an electric traction motor;
a first power source;
a second power source; and
a power controller;
wherein said first power source is a rechargeable traction battery pack;
wherein said second power source is a hydrogen fuel cell;
wherein said rechargeable traction battery pack having a first traction battery pack and a second traction battery pack;
wherein said second traction battery pack having a higher capacity than said first traction battery pack; and
further wherein said rechargeable traction battery pack and said hydrogen fuel cell switchable as a primary power source of the self-charging battery powered electric vehicle.

2. The self-charging battery powered electric vehicle of claim 1, wherein said first traction batter pack having a capacity from 20 kWh to 38 kWh.

3. The self-charging battery powered electric vehicle of claim 2, wherein said second traction battery pack having a capacity from 36 kWh to 50 kWh.

4. The self-charging battery powered electric vehicle of claim 1, wherein when said first traction battery pack is reduced to below a predetermined level of a total capacity of said first traction battery pack, said power controller switches from said first traction battery pack to said second traction battery pack.

5. The self-charging battery powered electric vehicle of claim 4, wherein said predetermined level is 20%.

6. The self-charging battery powered electric vehicle of claim 5, wherein said hydrogen fuel cell having a plurality of selectively removable hydrogen tanks.

7. The self-charging battery powered electric vehicle of claim 6, wherein said hydrogen fuel cell having at least one fixed hydrogen tank.

8. The self-charging battery powered electric vehicle of claim 7, wherein said hydrogen fuel cell charges said first traction battery pack when said first traction battery pack is not actively driving said electric traction motor.

9. The self-charging battery powered electric vehicle of claim 8, wherein said hydrogen fuel cell charges said second traction battery pack when said second traction battery pack is not actively driving said electric traction motor.

10. The self-charging battery powered electric vehicle of claim 9, wherein said hydrogen fuel cell is the primary power source for said electric traction motor.

11. A self-charging battery powered electric vehicle comprising:
an electric traction motor;
a first power source;
a second power source;
a power controller; and
a hydrogen supply module;
wherein said first power source is a rechargeable traction battery pack;
wherein said second power source is a hydrogen fuel cell;
wherein said rechargeable traction battery pack having a first traction battery pack and a second traction battery pack;
wherein said second traction battery pack having a higher capacity than said first traction battery pack;
wherein said hydrogen fuel cell having a plurality of selectively removable hydrogen tanks;
wherein said hydrogen fuel cell having at least one fixed hydrogen tank;
wherein said hydrogen supply module supplies hydrogen to said plurality of selectively removable hydrogen tanks and said at least one fixed hydrogen tank;
wherein each of said plurality of selectively removable hydrogen tanks having a capacity of up to 2 kg of compressed hydrogen gas;
wherein said at least one fixed hydrogen tank having a capacity of up to 3 kg of compressed hydrogen gas; and
further wherein said rechargeable traction battery pack and said hydrogen fuel cell switchable as a primary power source of the self-charging battery powered electric vehicle.

12. The self-charging battery powered electric vehicle of claim 11, wherein said first traction batter pack having a capacity from 20 kWh to 38 kWh, and further wherein said second traction battery pack having a capacity from 36 kWh to 50 kWh.

13. The self-charging battery powered electric vehicle of claim 11, wherein when said first traction battery pack is reduced to below a predetermined level of a total capacity of said first traction battery pack, said power controller switches from said first traction battery pack to said second traction battery pack.

14. The self-charging battery powered electric vehicle of claim 13, wherein said predetermined level is 20%.

15. The self-charging battery powered electric vehicle of claim 14, wherein said hydrogen fuel cell charges said first traction battery pack when said first traction battery pack is not actively driving said electric traction motor.

16. The self-charging battery powered electric vehicle of claim 15, wherein said hydrogen fuel cell charges said second traction battery pack when said second traction battery pack is not actively driving said electric traction motor.

17. The self-charging battery powered electric vehicle of claim 16, wherein said hydrogen fuel cell is the primary power source for said electric traction motor.

18. A self-charging battery powered electric vehicle comprising:
an electric traction motor;
a first power source;
a second power source;
a power controller; and
a hydrogen supply module;
wherein said first power source is a rechargeable traction battery pack;
wherein said second power source is a hydrogen fuel cell;
wherein said rechargeable traction battery pack having a first traction battery pack and a second traction battery pack;
wherein said second traction battery pack having a higher capacity than said first traction battery pack;
wherein said hydrogen fuel cell having a plurality of selectively removable hydrogen tanks;
wherein said hydrogen fuel cell having at least one fixed hydrogen tank;
wherein said hydrogen supply module supplies hydrogen to said plurality of selectively removable hydrogen tanks and said at least one fixed hydrogen tank;
wherein said hydrogen fuel cell charges said first traction battery pack when said first traction battery pack is not actively driving said electric traction motor;
wherein said hydrogen fuel cell charges said second traction battery pack when said second traction battery pack is not actively driving said electric traction motor; and
further wherein said rechargeable traction battery pack and said hydrogen fuel cell switchable as a primary power source of the self-charging battery powered electric vehicle.

19. The self-charging battery powered electric vehicle of claim 18, wherein said first traction batter pack having a capacity from 20 kWh to 38 kWh, and further wherein said second traction battery pack having a capacity from 36 kWh to 50 kWh.

20. The self-charging battery powered electric vehicle of claim 18, wherein when said first traction battery pack is reduced to below a predetermined level of a total capacity of said first traction battery pack, said power controller switches from said first traction battery pack to said second traction battery pack, and further wherein said predetermined level is 20%.
